(19) United States
(12) Patent Application Publication
(10) Pub. No.: US 2025/0044717 A1
(43) Pub. Date: Feb. 6, 2025

(54) IMAGE FORMING APPARATUS

(71) Applicant: SHARP KABUSHIKI KAISHA, Osaka (JP)

(72) Inventor: SHOJI NAKAI, Osaka (JP)

(21) Appl. No.: 18/782,590

(22) Filed: Jul. 24, 2024

(30) Foreign Application Priority Data
Aug. 3, 2023 (JP) 2023-127209

(51) Int. Cl. G03G 9/08; G03G 9/113

(52) U.S. Cl. CPC G03G 9/0819; G03G 9/0802; G03G 9/1136

(57) ABSTRACT

In an image forming apparatus, a two-component developer including an initial toner and a carrier is previously charged into a developer tank, and a replenishment toner is replenished into the developer tank as the development proceeds. The image forming apparatus has the following configuration. The initial toner contains, as external additives, a fine powder prepared by adding silica to strontium titanate to form a core and hydrophobizing a surface of the core with a silane compound, and a silica particle, and does not contain any titanium dioxide particle or contains a titanium dioxide particle at 50% by mass or less of the fine powder. The replenishment toner contains, as external additives, a titanium dioxide particle and a silica particle, and does not contain the fine powder or contains the fine powder at 50% by mass or less of the titanium dioxide particle.

### BACKGROUND OF THE INVENTION

### Field of the Invention

The disclosure relates to an image forming apparatus.

### Description of the Background Art

In image forming apparatuses such as copiers, multifunctional machines, printers, and facsimile machines that utilize electrophotographic method, a toner is generally stuck to an electrostatic latent image formed on a surface of a photoconductor to form a toner image. Since the toner in an amount used to form the toner image is transferred from a developer tank to the photoconductor, a corresponding amount of toner is replenished into the developer tank from a toner cartridge. Generally, a toner including a toner particle with a surface stuck with external additives as illustrated in FIG. 2 is used.

Generally, due to an agitation stress in a developer tank, an electric charge amount of a developer charged into the developer tank is significantly decreased at a relatively early stage of use of the developer. For this reason, to secure an electric charge amount required for the developer to form an appropriate image at a stage of advanced product lifespan (life), it is effective to add a charge control agent having a high charging stability, such as a titanium dioxide (titanium (IV) oxide) particle, as an external additive for a toner.

In prior art, it is known that, in a developing method in which an electrostatic latent image formed on a surface of a photoconductor is developed using a toner, a void preventing agent is added to an initial toner (toner in the developer previously charged into the developer tank) and meanwhile no void preventing agent is added to a replenishment toner (toner for replenishment), and that at least one selected from a group consisting of metallic soap, titanium dioxide, strontium titanate, and strontium oxide is used as the void preventing agent, and that a fine powder of zinc stearate is used as the metallic soap.

However, when the toner is designed after taking a decrease in the electric charge amount at an early stage of use of the developer into account so that an appropriate electric charge amount can be secured at a stage of advanced product lifespan of the developer, the toner must be designed so that the electric charge amount is high at the early stage of use of the developer (see “HIGHLY CHARGED TONER” in FIG. 7), resulting in problems of poor image density at the early stage of use, and a problem of increased change in hue of the image due to the significant change in the electric charge amount.

If the external additives are different between the initial toner and the replenishment toner (if different types of additives are used), generally, there is a problem that the initial toner and the replenishment toner are insufficiently agitated, resulting in poor uniformity in the image density (color unevenness in the image), and fogging. The fogging refers to a phenomenon in which the toner is developed on a non-image area where the toner is originally not to be developed.

The image forming apparatus according to the present disclosure has been found in view of the circumstances described above, and a main object of the present disclosure is to provide an image forming apparatus that can maintain an excellent image density and uniformity and can suppress fogging over a long period of time by suppressing rapid changes in the electric charge amount of the developer at an early stage of use of the developer.

### SUMMARY OF THE INVENTION

In the image forming apparatus according to the present disclosure, which has been made to solve the above-mentioned problems, a two-component developer including an initial toner and a carrier is previously charged into a developer tank, and a replenishment toner is replenished into the developer tank as the development proceeds. The initial toner and the replenishment toner include a toner particle with a surface stuck with external additives. The initial toner contains, as external additives, a fine powder prepared by adding silica to strontium titanate to form a core and hydrophobizing a surface of the core with a silane compound, and a silica particle, and does not contain any titanium dioxide particle or contains a titanium dioxide particle at 50% by mass or less of the fine powder. The replenishment toner contains, as external additives, a titanium dioxide particle and a silica particle, and does not contain the fine powder or contains the fine powder at 50% by mass or less of the titanium dioxide particle.

In the above image forming apparatus, it is preferable that a molar ratio of silicon atom to titanium atom in the fine powder is 0.03 or higher and 1.00 or lower.

In the above image forming apparatus, it is preferable that a content of the fine powder based on 100 parts by mass of the toner particle in the initial toner is 0.3 part by mass or more and 1.5 part by mass or less, and a content of the titanium dioxide particle based on 100 parts by mass of the toner particle in the replenishment toner is 0.3 part by mass or more and 1.5 part by mass or less.

In the above image forming apparatus, it is preferable that, under a condition that the content of the fine powder based on 100 parts by mass of the toner particle in the initial toner is defined as A part by mass and the content of the titanium dioxide particle based on 100 parts by mass of the toner particle in the replenishment toner is defined as B part by mass, an equation “B−A=0.3 or less” is established.

In the above image forming apparatus, it is preferable that the toner particle in the initial toner and in the replenishment toner has a volume average particle diameter of 4 μm or larger and 9 μm or smaller, and the fine powder and the titanium dioxide particle in the initial toner and in the replenishment toner have an average primary particle diameter of 20 nm or larger and 60 nm or smaller.

In the above image forming apparatus, it is preferable that the silica particle as the external additive contained in the initial toner and the replenishment toner includes a first silica particle having an average primary particle diameter of 20 nm or smaller and a second silica particle having an average primary particle diameter of 80 nm or larger and 150 nm or smaller.

In the above image forming apparatus, it is preferable that a content of the silica particle based on 100 parts by mass of the toner particle in the initial toner is 1.5 part by mass or more and 3.0 part by mass or less, and a content of the silica particle based on 100 parts by mass of the toner particle in the replenishment toner is 1.5 part by mass or more and 3.0 parts by mass or less.

In the above image forming apparatus, it is preferable that, under a condition that an adhesion strength of the fine powder and the titanium dioxide particle to the toner particle is defined as X(Ti) and an adhesion strength of the silica particle to the toner particle is defined as X(Si) in the initial toner, a ratio X(Si)/X(Ti) is 1.1 or lower. Also it is preferable that, under a condition that an adhesion strength of the fine powder and the titanium dioxide particle to the toner particle is defined as Y(Ti) and an adhesion strength of the silica particle to the toner particle is defined as Y(Si) in the replenishment toner, a ratio Y(Si)/Y(Ti) is 1.1 or lower.

The image forming apparatus according to the present disclosure exhibits excellent effects, e.g. an excellent image density and uniformity can be maintained and fogging can be prevented over a long period of time by suppressing rapid changes in the electric charge amount of a developer at an early stage of use of the developer.

### BRIEF DESCRIPTION OF THE DRAWINGS

FIG. 1 is a schematic diagram illustrating a surface of a toner particle in an initial toner according to this embodiment.

FIG. 2 is a schematic diagram illustrating a surface of a toner particle in a general low-charged toner.

FIG. 3 is a schematic diagram illustrating a toner replacement in a developer tank of the image forming apparatus according to this embodiment.

FIG. 4 is a schematic diagram illustrating a toner replacement in a developer tank in a case that a general low-charged toner is used as the initial toner and a general high-charged toner is used as a replenishment toner.

FIG. 5 is a graph illustrating a relationship between an agitation time and an electric charge amount in the image forming apparatus according to this embodiment.

FIG. 6 is a graph illustrating a relationship between an agitation time and an electric charge amount in the case of FIG. 4.

FIG. 7 is a graph illustrating a relationship between an agitation time and an electric charge amount in a case that a low-charged toner and a high-charged toner are individually used alone.

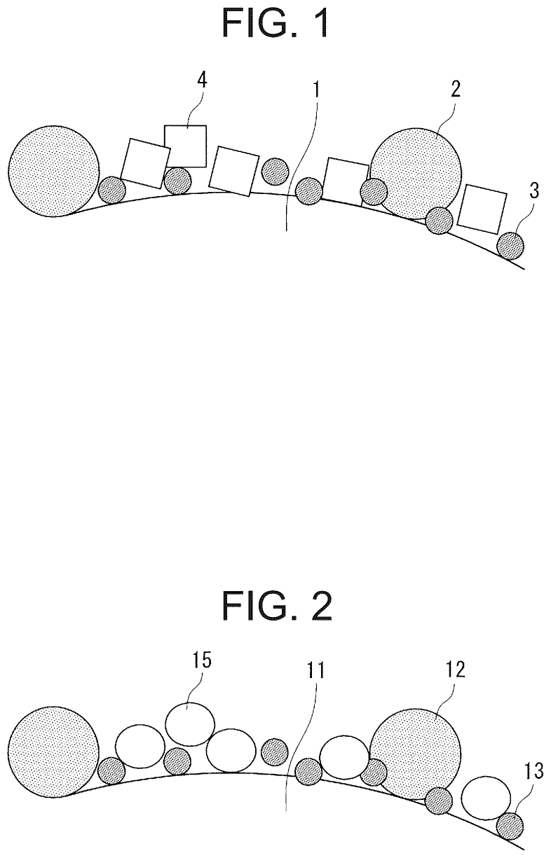

### DESCRIPTION OF THE PREFERRED EMBODIMENTS

The image forming apparatus according to the present disclosure will be explained below in detail. First, the overall characteristics of the image forming apparatus will be explained, followed by raw materials constituting the initial toner and the replenishment toner.

### 1. Image Forming Apparatus

In the image forming apparatus according to this embodiment, a two-component developer including an initial toner and a carrier is previously charged into a developer tank, and a replenishment toner is replenished into the developer tank as the development proceeds.

The initial toner and the replenishment toner used in the image forming apparatus according to this embodiment include a toner particle with a surface stuck with an external additive. The initial toner contains, as external additives, the “fine powder prepared by adding silica to strontium titanate to form a core and hydrophobizing a surface of the core with a silane compound” (hereinafter, this fine powder is also simply referred to as “fine powder”), and a silica particle, and does not contain any titanium dioxide particle or contains a titanium dioxide particle at 50% by mass or less of the fine powder. The replenishment toner contains, as external additives, a titanium dioxide particle and a silica particle, and does not contain any fine powder or contains a fine powder at 50% by mass or less of the titanium dioxide particle.

By using the initial toner as described above, the initial toner can be designed so as to have a relatively low electric charge amount compared to a case using an initial toner containing a large amount of titanium dioxide particle as an external additive, so that the electric charge amount of the developer at the early stage of use of the developer (hereinafter, also referred to as an early stage of printing) is proper. Furthermore, by using the replenishment toner as described above, the replenishment toner can be designed so as to have a relatively high electric charge amount, so that the electric charge amount of the developer at a stage of advanced product lifespan can be maintained at a high level. The image forming apparatus according to this embodiment having such a combination of the initial toner and the replenishment toner makes it possible to suppress image defects such as color unevenness, decrease in density, and change in line width of an image to form a high-quality image over a long period of time.

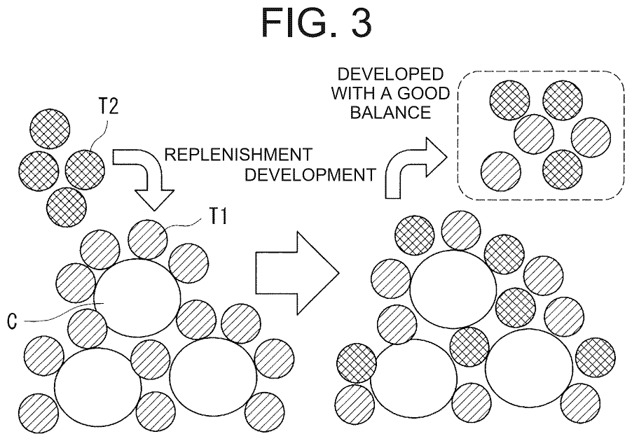

The “fine powder prepared by adding silica to strontium titanate to form a core and hydrophobizing a surface of the core with a silane compound” has a cube-like shape with rounded corners, and can acquire a high frictional force during the toner flow by adding (sticking) the fine powder to the surface of the toner particle. Thereby, when the initial toner stuck with this fine powder and the replenishment toner with the surface stuck with a high-fluidity particle such as a titanium dioxide particle are mixed, the toners can be easily and homogeneously agitated. There is a difference in the electric charge amount between the initial toner and the replenishment toner having different external additives as described above. As a result, an electrostatic attractive force is generated during the agitation, and therefore the toners can be easily and more homogeneously agitated. FIG. 3 is a schematic diagram illustrating a toner replacement in a developer tank in the image forming apparatus according to this embodiment. As illustrated in FIG. 3, in the configuration according to this embodiment, when a replenishment toner T2 is replenished into the two-component developer including an initial toner T1 and a carrier C and agitated in a developer tank, the initial toner T1 and the replenishment toner T2 can be easily and homogeneously dispersed as illustrated on the right side of FIG. 3. Consequently, the initial toner T1 and the replenishment toner T2 are developed with good balance, so that an image which can maintain a high quality over a long period of time can be formed.

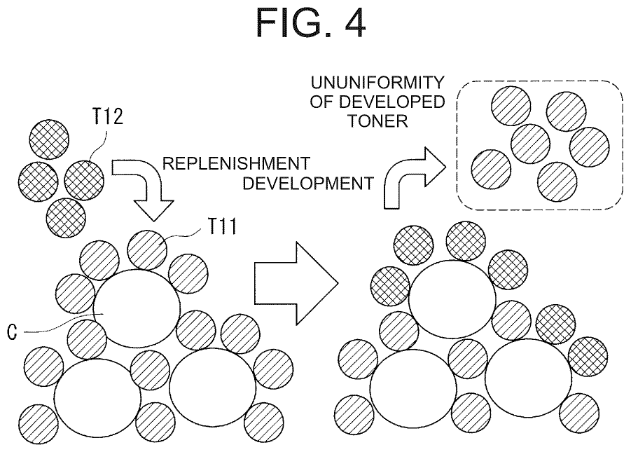

In contrast, FIG. 4 is a schematic diagram illustrating a toner replacement in a developer tank in a case that a general low-charged toner is used as the initial toner and a general high-charged toner is used as a replenishment toner. For example, when a low-charged spherical toner with a particle surface stuck with a charge control agent is used as an initial toner T11, the dissociation property from the surface of the carrier C is excessively enhanced, and when the replenishment toner T12 with a particle surface stuck with a titanium dioxide particle is replenished, the replacement of the toner stuck to the surface of the carrier C (replacement of the initial toner with the replenishment toner) rapidly proceeds, resulting in a problem of unevenness in the electric charge amount in the developer. For this reason, as illustrated in FIG. 4, there is a problem that the toner to be developed becomes ununiform, resulting in image defects such as poor uniformity in the image density (unevenness in the image density in one surface). Also, there is a problem that the combination of the general low-charged toner and high-charged toner causes unevenness in the electric charge amount in the developer, and therefore the electric charge amount of the developer unstably transitions as presented in FIG. 6, resulting in image defects such as increase in an image hue change accompanying a significant change in the electric charge amount.

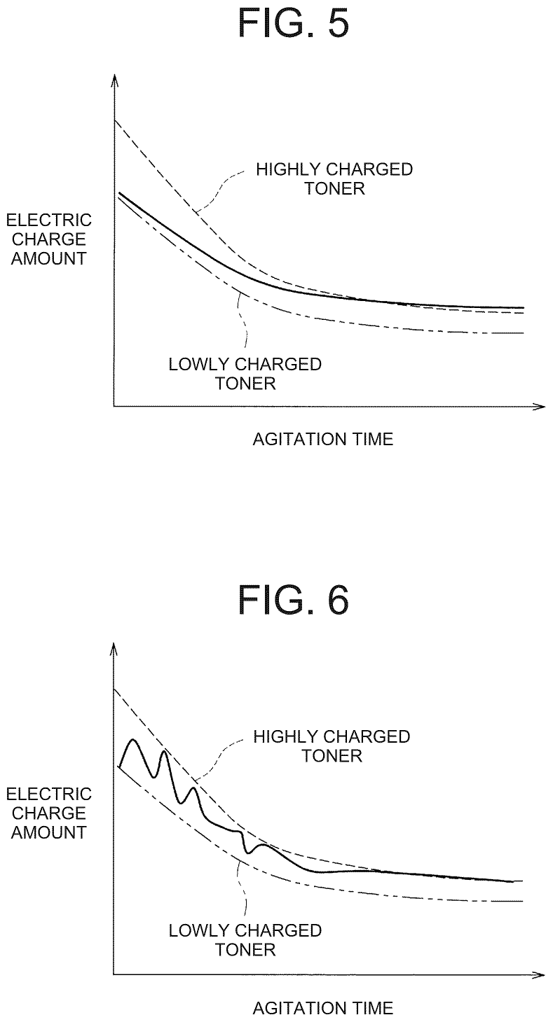

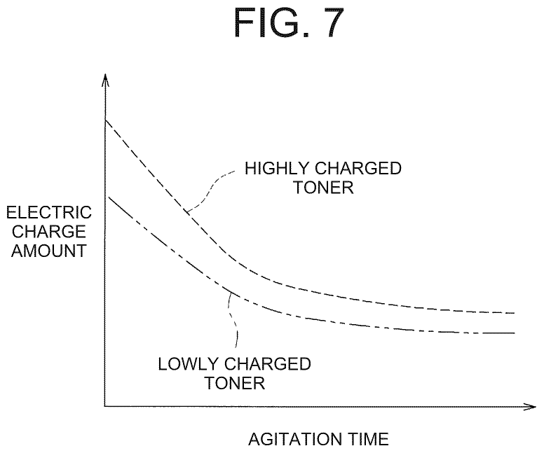

In the image forming apparatus according to this embodiment, when the “fine powder prepared by adding silica to strontium titanate to form a core and hydrophobizing a surface of the core with a silane compound” contained as an external additive in the initial toner has a certain degree of heteromorphism, the initial toner can continue to be held to some extent on the carrier surface owing to the strong frictional force of the initial toner. Thereby, the initial toner can be replaced with the replenishment at a proper speed, and therefore, even if there is a difference in the electric charge amount between the initial toner and the replenishment toner, unevenness in the electric charge amount in the developer can be suppressed, and as presented in FIG. 5, the electric charge amount of the developer stably transitions (transition of the electric charge amount with a gentle gradient), so that an image that can maintain a high quality over a long period of time can be formed.

### 2. Toner Particle

The initial toner and the replenishment toner according to this embodiment include a toner particle (toner core) with a surface stuck with an external additive. The toner particle according to this embodiment includes internal additives such as a colorant, a release agent, and a charge control agent, and a binder resin, and the internal additives are dispersed in the binder resin. As necessary, the toner particle may further contain optional components as long as the effects of the present disclosure are not impaired. The toner particle in the initial toner and the replenishment toner has a volume average particle diameter of e.g. 3 μm or larger and 10 μm or smaller, preferably 4 μm or larger and 9 μm or smaller, more preferably 5 μm or larger and 8 μm or smaller. If the volume average particle diameter of the toner particle is smaller than the lower limit described above, the adhesiveness between the toner and the carrier is significantly increased, thereby the initial toner is hardly replaced with the replenishment toner, and the uncharged toner may cause fogging. If the volume average particle diameter of the toner particle is larger than the upper limit described above, the adhesiveness between the toner and the carrier is lowered, thereby the initial toner is rapidly replaced with the replenishment toner, and the uniformity of the image density may be lowered (unevenness of the image density).

### <Binder Resin>

The toner particles constituting the initial toner and the replenishment toner according to this embodiment include a binder resin. The binder resin is not particularly limited, and any resin used in the electrophotographic field can be used. Examples of the binder resin include polystyrene resins such as styrene-acrylic resins, (meth)acrylate resins, polyolefin resins, polyurethane resins, and epoxy resins. Each of these resins may be used alone or in combination of two or more types. Above all, a polystyrene resin and a polyester resin are preferable, and a polyester resin is particularly preferable.

Preferable examples of the polystyrene resin include styrene-acrylic resins (styrene-acrylic copolymer resin). Examples of a styrene monomer usable as a raw resin include styrene derivatives such as styrene, o-methylstyrene, m-methylstyrene, p-methylstyrene, α-methylstyrene, p-ethylstyrene, and 2,4-dimethylstyrene. Examples of the acrylic monomer include acrylic and methacrylic derivatives such as acrylic acid, methyl acrylate, ethyl acrylate, n-butyl acrylate, isobutyl acrylate, propyl acrylate, octyl acrylate, 2-chloroethyl acrylate, phenyl acrylate, methacrylic acid, methyl methacrylate, ethyl methacrylate, propyl methacrylate, n-butyl methacrylate, isobutyl methacrylate, n-octyl methacrylate, 2-ethylhexyl methacrylate, phenyl methacrylate, and dimethylamino methacrylate.

Examples of the raw resin include vinyl monomers such as maleic anhydride, monomethyl maleate, monoethyl maleate, monophenyl maleate, monoallyl maleate, and divinylbenzene.

The polyester resin used for the binder resin is usually obtained by polycondensing one or more selected from divalent alcohol components and polyvalent alcohol components having 3 or more valences, and one or more selected from divalent carboxylic acids and polyvalent carboxylic acids having 3 or more valences through an esterification reaction or a transesterification reaction by a known method.

The condition for the polycondensation reaction should be appropriately set depending on the reactivity of the monomer components, and the reaction should be terminated at a timing when the polymer acquires suitable physical properties. For example, the reaction temperature is about 170° C. to 250° C., and the reaction pressure is about 5 mmHg to normal pressure.

Examples of the divalent alcohol component include alkylene oxide adducts of bisphenol A, such as polyoxypropylene (2.2)-2,2-bis(4-hydroxyphenyl) propane, polyoxypropylene (3.3)-2,2-bis(4-hydroxyphenyl) propane, polyoxypropylene (2.0)-2,2-bis(4-hydroxyphenyl) propane, polyoxypropylene (2.0)-polyoxyethylene (2.0)-2,2-bis(4-hydroxyphenyl) propane, and polyoxypropylene (6)-2,2-bis(4-hydroxyphenyl) propane; diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenol A; propylene adducts of bisphenol A; ethylene adducts of bisphenol A; and hydrogenated bisphenol A.

Examples of the polyvalent alcohol components having 3 or more valences include sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

For the toner particle according to this embodiment, each of the divalent alcohol components and the polyvalent alcohol components having 3 or more valences may be used alone or in combination of two or more types.

Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, n-dodecylsuccinic acid, n-octylsuccinic acid, isooctenylsuccinic acid, isooctylsuccinic acid, as well as acid anhydrides and lower alkyl esters thereof.

Examples of the polyvalent carboxylic acid having 3 or more valences include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, Empol trimer acid, as well as acid anhydrides and lower alkyl esters thereof.

For the toner particle according to this embodiment, each of the divalent dicarboxylic acids and the polyvalent carboxylic acids having 3 or more valences may be used alone or in combination of two or more types.

Preferably, the polyester resin has a weight average molecular weight of 3,000 or more and 50,000 or less. If the weight average molecular weight is less than the lower limit described above, releasability on a high-temperature side of a fixable region (non-offset region) may deteriorate. On the other hand, if the weight average molecular weight is more than the upper limit described above, a low-temperature fixability may deteriorate.

Preferably, the polyester resin has an acid value of 5 mgKOH/g or higher and 30 mgKOH/g or lower. If the acid value is less than the lower limit described above, the chargeability of the polyester resin is lowered, and the charge control agent is less likely to be dispersed in the polyester resin, which may adversely affect the charge rising property and the charge stability during continuous printing. On the other hand, if the acid value is higher than the upper limit described above, the hygroscopicity increases, and therefore the chargeability may be unstable.

### <Internal Additive>

### Wax

The toner particle according to this embodiment may include wax as a release agent. As wax, wax for the electrophotographic field can be used, and examples thereof include paraffin wax, microcrystalline wax, Fisher-tropsch wax, polyethylene wax, polypropylene wax, carnauba wax, and synthetic ester wax. Each wax may be used alone or in combination of two or more types. A content of wax in the toner particle is preferably 0.5% by mass or more and 10% by mass or less.

### Colorant

The toner particle according to this embodiment may contain a colorant. Examples of the colorant include an organic pigment, an organic dye, an inorganic pigment, and an inorganic dye, which are used in the electrophotographic field.

Examples of a black colorant include carbon black, copper oxide, manganese dioxide, aniline black, activated carbon, non-magnetic ferrite, magnetic ferrite, and magnetite.

Examples of a yellow colorant include C. I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185.

Examples of a magenta colorant include C. I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of a cyan colorant include C. I. Pigment Blue 15, C.I. Pigment Blue 15:2, C.I. Pigment Blue 15:3, C.I. Pigment Blue 16, and C.I. Pigment Blue 60.

The content of the colorant in the toner particle is preferably 3 parts by mass or more and 10 parts by mass or less. The colorant may be used in a masterbatch form so as to be uniformly dispersed in the binder resin.

### Charge Control Agent

The toner particle according to this embodiment may contain a charge control agent. The charge control agent is added to provide chargeability suitable for the toner. The charge control agent is not particularly limited, and any charge control agent for controlling a positive charge and a negative charge, which is used in the electrophotographic field, can be used.

Examples of the charge control agent for controlling a positive charge include a quaternary ammonium salt, a pyrimidine compound, a triphenylmethane derivative, a guanidine salt, and an amidine salt.

Examples of the charge control agent for controlling a negative charge include a metal-containing azo compound, an azo complex dye, a metal complex or metal salt of salicylic acid and a derivative thereof (metal is chromium, zinc, zirconium, etc.), an organic bentonite compound, and a boron compound.

Each of these charge control agents may be used alone or in combination of two or more types. A content of the charge control agent in the toner particle is preferably 0.5% by mass or more and 5% by mass or less.

### 2. External Additive

The initial toner according to this embodiment contains, as external additives, a fine powder and a silica particle, and does not contain any titanium dioxide particle or contains a titanium dioxide particle at 50% by mass or less of the fine powder. More preferably, the initial toner according to this embodiment contains, as external additives, a fine powder and a silica particle, and does not contain any titanium dioxide particle.

The replenishment toner contains, as external additives, a titanium dioxide particle and a silica particle, and does not contain any fine powder or contains a fine powder at 50% by mass or less of the titanium dioxide particle. More preferably, the replenishment toner according to this embodiment contains, as external additives, a titanium dioxide particle and a silica particle, and does not contain any fine powder.

A fine powder prepared by adding silica to strontium titanate to form a core and hydrophobizing a surface of the core with a silane compound can be produced, for example, by the following procedures (1) to (5).

(1) Metatitanic acid prepared by a sulfuric acid method is subjected to desulfurization bleaching treatment, subsequently desulfurized by adding a sodium hydroxide aqueous solution, then neutralized with hydrochloric acid, and filtrated and washed with water to obtain a washed cake.

(2) Water is added to the washed cake to form a slurry, to which hydrochloric acid is added for peptization. This slurry is referred to as solution 1. The solution 1 was mixed with a strontium chloride aqueous solution as solution 2 and a sodium silicate aqueous solution as solution 3. A mixing ratio of the solution 1, solution 2, and solution 3 is set so that a molar ratio (Sr+Si)/Ti is 1.2.

(3) The mixed solution was heated to 90° C. under a nitrogen gas atmosphere and stirred for 2 hours while adding a sodium hydroxide aqueous solution, and then the reaction is terminated.

(4) The slurry after the reaction is cooled to 50° C., to which hydrochloric acid is added, and stirred for 2 hours to obtain a precipitate. This precipitate is washed, separated by filtration, and dried.

(5) The dried product is pulverized using a blender for 1 minute, from which a coarse powder is removed using a sieve having an opening of 32 μm to obtain a fine powder base material (core). A surface of this fine powder base material is coated with a silane coupling agent. Examples of the surface coating method with a silane coupling agent include surface treatments, commonly used in the art, using hexamethyldisilazane (HMDS), dimethyldichlorosilane (DDS), octylsilane (OTAS), polydimethylsiloxane (PDMS), or the like.

As in this production example, a particle prepared by adding silica to strontium titanate to form a core and hydrophobizing a surface of the core with a silane compound has a relatively spherical shape, and has improved dispersibility and fluidity, and suppressed abradability as compared with the particle with a core to which silica is not added.

A molar ratio Si/Ti of silicon atom to titanium atom in the fine powder is preferably 0.03 or higher and 1.00 or lower, more preferably 0.03 or higher and 0.10 or lower. The molar ratio Si/Ti represents a content ratio of silica in the fine powder. If the molar ratio Si/Ti is lower than the lower limit described above, the shape of the fine powder is angular, and therefore the adhesiveness between the carrier and the toner excessively increases, and the fine powder may not be sufficiently agitated with the replenishment toner, resulting in possibility of deteriorated image density uniformity (unevenness of the image density on one surface). If the molar ratio Si/Ti is higher than the upper limit described above, the negative chargeability of the fine powder increases, resulting in possibility of decreased image density at the early stage of printing.

The titanium dioxide particle may be of an anatase type or a rutile type. As a method for producing an anatase type titanium dioxide particle, for example, as described in the prior art, raw materials such as ilmenite ore are dissolved in sulfuric acid, this solution is hydrolyzed, granulated, dried, and then sintered at a high temperature to obtain a titanium dioxide particle. As a method for producing a rutile type titanium dioxide particle, for example, as described in the prior art, a titanium tetrachloride aqueous solution is hydrolyzed to prepare a fine titania sol having a rutile nucleus, and this sol is fractionated and then heat-treated to obtain a titanium dioxide particle. The surface of the titanium dioxide particle may be hydrophobized. As the hydrophobization treatment, the surface of the particle is coated with a silane coupling agent. Examples of the surface coating method with a silane coupling agent include surface treatments commonly used in the art using hexamethyldisilazane, dimethyldichlorosilane, octylsilane, polydimethylsiloxane, or the like.

In the image forming apparatus according to this embodiment, a content of the fine powder based on 100 parts by mass of the toner particle in the initial toner is preferably 0.3 part by mass or more and 1.5 part by mass or less, more preferably 0.7 part by mass or more and 1.3 part by mass or less. A content of the titanium dioxide particle based on 100 parts by mass of the toner particle in the replenishment toner is preferably 0.3 parts by mass or more and 1.5 parts by mass or less, more preferably 0.7 parts by mass or more and 1.3 parts by mass or less. If the content of the fine powder in the initial toner or the content of the titanium dioxide particle in the replenishment toner is less than the lower limit described above, the electric charge amount of the toner excessively increases, and good image quality may not be obtained both at the early stage of printing and after continuous printing. If the content of the fine powder in the initial toner or the content of the titanium dioxide particle in the replenishment toner is more than the upper limit described above, the electric charge amount of the toner excessively decreases, and fogging is likely to occur both at the early stage of printing and at a stage of advanced product lifespan.

In the image forming apparatus according to this embodiment, it is preferable that, under a condition that the content of the fine powder based on 100 parts by mass of the toner particle in the initial toner is defined as A part by mass and the content of the titanium dioxide particle based on 100 parts by mass of the toner particle in the replenishment toner is defined as B part by mass, a solution of an equation “B−A” is preferably 0.3 or smaller, more preferably 0.2 or smaller. If the solution of the equation “B−A” exceeds the upper limit described above, the difference in the electric charge amount between the initial toner and the replenishment toner is large, and therefore the difference in the electric charge amount between the early stage of printing and the stage of advanced product lifespan excessively increases, resulting in a possibility that the change in hue during continuous printing increases.

Average primary particle diameters of the fine powder and the titanium dioxide particle in the initial toner and the replenishment toner are preferably 20 nm or larger and 60 nm or smaller, more preferably 25 nm or larger and 50 nm or smaller. If the average primary particle diameters of the fine powder or the titanium dioxide particles are smaller than the lower limit described above, the fluidity of the toner increases and the difference in fluidity between the initial toner and the replenishment toner decreases, resulting in possibility of rapid replacement of the initial toner with the replenishment toner, and unevenness in image density. If the average primary particle diameter of the fine powder or the titanium dioxide particle is larger than the upper limit described above, the fluidity of the toner decreases and the difference in fluidity between the initial toner and the replenishment toner increases, resulting in possibility of a rough image. The “roughness” refers to an ununiform image quality and a rough feel.

Preferably, the silica particle as the external additive contained in the initial toner and the replenishment toner according to this embodiment includes a first silica particle having an average primary particle diameter of 20 nm or smaller (silica particle with a small particle diameter) and a second silica particle having an average primary particle diameter of 80 nm or larger and 150 nm or smaller (silica particle with a large particle diameter). More preferably, the first silica particle has an average primary particle diameter of 15 nm or smaller, and the second silica particle has an average primary particle diameter of 90 nm or larger 130 nm or smaller. If the average primary particle diameter of the first silica particle is larger than the upper limit described above, the fluidity of the toner decreases, resulting in possibility of a rough image and an uneven image density. If the average primary particle diameter of the second silica particle is smaller than the lower limit described above, the durability of the toner decreases, and, as a result, the image may become rough as the product lifespan proceeds. If the average primary particle diameter of the second silica particle is larger than the upper limit described above, the fluidity of the toner decreases, resulting in possibility of a rough image and an uneven image density.

In the image forming apparatus according to this embodiment, a content of the silica particle based on 100 parts by mass of the toner particle in the initial toner is preferably 1.5 part by mass or more and 3.0 parts by mass or less, more preferably 2 parts by mass or more and 2.8 parts by mass or less. A content of the silica particle based on 100 parts by mass of the toner particle in the replenishment toner is preferably 1.5 part by mass or more and 3.0 parts by mass or less, more preferably 2 parts by mass or more and 2.8 parts by mass or less. If the content of the silica particle in the initial toner or the replenishment toner is less than the lower limit described above, the durability of the toner decreases, and a rough image and fogging may occur as the product lifespan proceeds. If the content of the silica particle in the initial toner or the replenishment toner is more than the upper limit described above, the adhesion strength of the fine powder and the titanium dioxide particle to the toner particle decreases, therefore carrier contamination due to these external additives transferred (stuck) to the carrier is likely to occur, and, as a result, the electric charge amount is likely to decrease to cause fogging as the product lifespan proceeds.

In the image forming apparatus according to this embodiment, under a condition that an adhesion strength of the fine powder and the titanium dioxide particle to the toner particle in the initial toner is defined as X(Ti) and an adhesion strength of the silica particle to the toner particle is defined as X(Si), a ratio X(Si)/X(Ti) is preferably 1.1 or lower, more preferably 1 or lower. Under a condition that an adhesion strength of the fine powder and the titanium dioxide particle to the toner particle in the replenishment toner is defined as Y(Ti) and an adhesion strength of the silica particle to the toner particle is defined as Y(Si), a ratio Y(Si)/Y(Ti) is preferably 1.1 or lower, more preferably 1 or lower. If the adhesion strength ratio X(Si)/X(Ti) or Y(Si)/Y(Ti) is higher than the upper limit described above, carrier contamination is likely to proceed, and as a result, the electric charge amount is likely to decrease to cause fogging as the product lifespan proceeds.

### 3. Two-Component Developer and Carrier

The two-component developer according to this embodiment includes a toner and a carrier. The two-component developer that has been previously charged into the developer tank of the image forming apparatus according to this embodiment includes the initial toner and the carrier. The two-component developer can be produced by mixing the toner and the carrier using a known mixer. A mass ratio between the toner and the carrier is not particularly limited and is, for example, 3:97 to 12:88.

The carrier is agitated and mixed with the toner in a developer tank to provide the toner with a desired charge. The carrier also serves as an electrode between a developing device and a photoconductor and carries the charged toner to an electrostatic latent image on the surface of the photoconductor to form a toner image. The carrier is held on a developing roller of the developing device by a magnetic force and acts on the developing. Then, the carrier returns to the developer tank again and is mixed with a new toner and agitated again, and repeatedly used until the lifespan thereof expires.

Preferably, the carrier has a carrier core material, and a resin coating layer that covers the carrier core material. The carrier core material is not particularly limited as long as it is used in the electrophotographic field. Examples of the material constituting the carrier core material include magnetic metals such as iron, copper, nickel, and cobalt; and magnetic metal oxides such as ferrite and magnetite. The volume average particle diameter of the carrier core material is not particularly limited and is preferably 30 μm or larger and 100 μm or smaller. Preferably, the resin coating layer contains a silicone resin or an acrylic resin. The silicone resin can slow down progression of contamination in a carrier coat layer and is suitable for use in long-life applications.

### EXAMPLES

The image forming apparatus according to the present disclosure will be specifically explained below, with reference to Examples and Comparative Examples. First, various measurement methods and evaluation methods will be explained.

### <Measurement Method>

### Method for Measuring Volume Average Particle Diameter of Toner Particle

To 50 ml of electrolytic solution (trade name: ISOTON-II, manufactured by Beckman Coulter, Inc.), 20 mg of toner particle and 1 ml of sodium alkylether sulfate were added, which was dispersed using an ultrasonic disperser (desktop two-frequency ultrasonic washer, Model; VS-D100, manufactured by AS ONE Corporation) at a frequency of 20 kHz for 3 minutes to obtain a measurement sample. A particle size distribution of the obtained measurement sample was measured using a particle size distribution meter (Model: Multisizer 3, manufactured by Beckman Coulter, Inc.) under a condition of an aperture diameter of 100 μm and a measured particle number of 50000 counts, to determine a volume-average particle diameter from a volume particle size distribution of the sample particle.

### Method for Measuring Adhesion Strength of External Additive

The adhesion strength of each external additive to the toner particle was measured according to the following procedures.

(1) To 40 ml of 0.2 mass % Triton (polyoxyethylene octylphenyl ether) aqueous solution, 2.0 g of toner is added and stirred for 1 minute.

(2) The aqueous solution is ultrasonicated using an ultrasonic homogeniser (Model: US-300T, manufactured by NIHONSEIKI KAISHA LTD.). (output power: 40 uA, 4 minutes)

(3) After the ultrasonication, the aqueous solution is allowed to stand for 3 hours to separate the toner and the liberated external additive.

(4) The supernatant is removed, then about 50 ml of pure water is added to the precipitate, which is stirred for 5 minutes.

(5) The solution is subjected to suction filtration using a membrane filter (manufactured by ADVANTEC Co.,LTD.) having a pore diameter of 1 μm.

(6) The toner remaining on the filter is vacuum-dried overnight.

(7) The intensities of elements (Si and Ti) in the external additives contained in 1 g of toner before and after the series of treatments (1) to (6) are analyzed using a fluorescent X-ray analyzer (Model: ZSX Primus II, manufactured by Rigaku Corporation) to calculate an adhesion strength of each external additive according to the following equation.

$$Adhesion strength of external additive containing Si [ \% ] = \{ ( Si strength after treatment ) / ( Si strength before treatment ) \} \times 100 \qquad ( I )$$

$$Adhesion strength of external additive containing Ti [ \% ] = \{ ( Ti strength after treatment ) / ( Ti strength before treatment ) \} \times 100 \qquad ( II )$$

Specifically, as for the initial toner, the adhesion strength X(Ti) of the fine powder and the titanium dioxide particle to the toner particle is calculated according to the above formula (II), and the adhesion strength X(Si) of the silica particle to the toner particle is calculated according to the above formula (I). Similarly, as for the replenishment toner, the adhesion strength Y(Ti) of the fine powder and the titanium dioxide particle to the toner particle is calculated according to the above formula (II), and the adhesion strength Y(Si) of the silica particle to the toner particle is calculated according to the above formula (I).

### Method for Evaluating Image Density

The prepared developer and toner were charged into a developing device and a toner cartridge respectively in a color multifunctional machine (Model: MX-8081, manufactured by SHARP CORPORATION). Subsequently, a continuous printing test was performed on 2000 sheets of A4 paper in an environment at a temperature of 25° C. and a humidity of 50% so that 10×10 mm-square solid images were formed on three positions i.e. a middle portion and both end portions in the axial direction of the developing roller. The first printed sheet was referred to as a first print sample and the two thousandth printed sheet was referred to as a second print sample. For each of the first and second print samples, image densities were measured at arbitrary 10 positions to calculate an average value of the image density.

Based on the calculated average value of the image densities, the image density was evaluated in accordance with the following criteria.

Excellent: The image density average value is 1.45 or higher.

Good: The image density average value is 1.30 or higher and lower than 1.45.

Fair: The image density average value is 1.15 or higher and lower than 1.30.

Poor: The image density average value is lower than 1.15.

### Method for Evaluating Uniformity of Image Density

The prepared developer and toner were charged into a developing device and a toner cartridge respectively in a color multifunctional machine (Model: MX-8081, manufactured by SHARP CORPORATION). Subsequently, a continuous printing test was performed on 2000 sheets of A4 paper in an environment at a temperature of 25° C. and a humidity of 50% so that 10×10 mm-square solid images were formed on three positions i.e. a middle portion and both end portions in the axial direction of the developing roller. The first printed sheet was referred to as a first print sample and the two thousandth printed sheet was referred to as a second print sample. For each of the first and second print samples, the image densities were measured at arbitrary 10 points to calculate a standard deviation of the image density. The larger the standard deviation is, the lower the uniformity is.

Based on the calculated standard deviation, the image density was evaluated in accordance with the following criteria.

Excellent: The standard deviation is lower than 0.1.

Good: The standard deviation is 0.1 or higher and lower than 0.2.

Fair: The standard deviation is 0.2 or higher and lower than 0.4.

Poor: The standard deviation is 0.4 or higher.

### Method for Evaluating Fogging

When the fogging value is measured, an image in which 10% of a printable area of A4 paper is filled-in with a toner is printed, and a brightness of a particular region where the image is not filled-in is measured using a colorimetric difference meter (Model: ZE6000, manufactured by NIPPON DENSHOKU INDUSTRIES Co.,LTD). The difference between this brightness and the brightness previously measured before printing is defined as a fogging value.

The prepared developer and toner were charged into a developing device and a toner cartridge respectively in a color multifunctional machine (Model: MX-8081, manufactured by SHARP CORPORATION). Subsequently, a continuous printing test was performed to print the images on 2000 sheets of A4 paper in an environment at a temperature of 25° C. and a humidity of 50%. The first printed sheet was referred to as a first print sample and the two thousandth printed sheet was referred to as a second print sample.

The fogging values of the first and second print samples were measured to evaluate the fogging in accordance with the following criteria.

Excellent: The fogging value is lower than 1.4.

Good: The fogging value is 1.4 or higher and lower than 1.7.

Fair: The fogging value is 1.7 or higher and lower than 2.0.

Poor: The fogging value is 2.0 or higher.

### <Preparation of Toner Raw Material>

### Preparation of Fine Powder

Metatitanic acid prepared by a sulfuric acid method was subjected to deironization bleaching treatment, subsequently desulfurized by adding a sodium hydroxide aqueous solution, then neutralized with hydrochloric acid, and filtrated and washed with water to obtain a washed cake. Water was added to the washed cake to prepare a slurry, to which hydrochloric acid was added for peptization. This slurry was referred to as solution 1. The solution 1 was mixed with a strontium chloride aqueous solution as solution 2 and a sodium silicate aqueous solution as solution 3. A mixing ratio of the solution 1, solution 2, and solution 3 was set so that a molar ratio (Sr+Si)/Ti was 1.2. This mixed solution was heated to 90° C. under a nitrogen gas atmosphere and stirred for 2 hours while adding a sodium hydroxide aqueous solution, and then the reaction was terminated. After the reaction, the slurry was cooled to 50° C., to which hydrochloric acid was added, and the mixture was stirred for 2 hours. A precipitate obtained after the stirring was separated by washing and filtration, and then dried. This dried product was pulverized with an airflow pulverizer, coarse powder was removed with a sieve, then a surface of a resulting fine powder base material (core) was coated with octylsilane to obtain a “fine powder prepared by adding silica to strontium titanate to form a core and hydrophobizing a surface of the core with a silane compound”.

“Fine Powder 1” to “Fine Powder 10” having different molar ratios of silicon atom to titanium atom (Si/Ti) in the fine powder and different average primary particle diameters were prepared according to the above procedure. The properties of the “fine powder 1” to “fine powder 10” are presented in Table 1 below.

TABLE 1

| | Si/Ti | Average primary |
|---|---|---|
| Sample name | molar ratio | particle diameter [nm] |
| Fine powder 1 | 0.05 | 34 |
| Fine powder 2 | 0.03 | 34 |
| Fine powder 3 | 0.95 | 34 |
| Fine powder 4 | 0.01 | 34 |
| Fine powder 5 | 1.10 | 34 |
| Fine powder 6 | 0.05 | 21 |
| Fine powder 7 | 0.05 | 57 |
| Fine powder 8 | 0.05 | 17 |
| Fine powder 9 | 0.05 | 64 |
| Fine powder 10 | 0.00 | 34 |

### Preparation of Titanium Dioxide Particle

A wet precipitation method was performed, in which ilmenite ore was dissolved in sulfuric acid to separate iron powder, and TiOSO₄ was hydrolyzed to obtain TiO(OH)₂. In the process of obtaining TiO(OH)₂, dispersion adjustment and water washing were performed for hydrolysis and nucleation. Then, 20 parts by mass of isobutyltrimethoxysilane was dripped into 100 parts by mass of the resulting TiO(OH)₂ dispersed in 1000 ml of water, while stirring the mixture at room temperature. Subsequently, this mixture was filtered and repeatedly washed with water, then dried, sintered, and pulverized with an airflow pulverizer to obtain an anatase type titanium dioxide base material. The base material was hydrophobized by coating its surface with hexamethyldisilazane, to obtain a titanium dioxide particle.

According to the above procedure, “titanium dioxide 1” to “titanium dioxide 5” having different average primary particle diameters were prepared. Average primary particle diameters of the “titanium dioxide 1” to “titanium dioxide 5” are presented in Table 2 below.

TABLE 2

| | Average primary |
|---|---|
| Sample name | particle diameter [nm] |
| Titanium dioxide 1 | 40 |
| Titanium dioxide 2 | 22 |
| Titanium dioxide 3 | 56 |
| Titanium dioxide 4 | 18 |
| Titanium dioxide 5 | 63 |

### First Silica Particle (Silica Particle Having Small Particle Diameter) for Use

As “small silica 1”, a fumed silica under trade name “TG-3155F” manufactured by Cabot Corporation (average primary particle diameter: 12 nm, surface treatment agent: hexamethyldisilazane/polydimethylsiloxane) was used.

As “small silica 2”, a fumed silica under trade name “TG-709F” manufactured by Cabot Corporation (average primary particle diameter: 18 nm, surface treatment agent: dimethyldichlorosilane) was used.

As “small silica 3”, a fumed silica under trade name “TG-6110F” manufactured by Cabot Corporation (average primary particle diameter: 23 nm, surface treatment agent: hexamethyldisilazane) was used.

Preparation of Second Silica Particle (Silica Particle having Large Particle Diameter) A stirrer, a dropping funnel, and a thermometer were set in a glass reactor, in which ammonia water was added to ethanol, stirred, and maintained at 20° C. Tetraethoxysilane was dripped into this solution for 60 minutes for reaction. Also after the dripping, the stirring was continued at 20° C. for 5 hours to obtain a silica sol suspension. This silica sol suspension was heated to remove ethanol, to which toluene was subsequently added, and this suspension was further heated to remove water. Then, to this suspension, hexamethyldisilazane was added at 40% by mass based on the silica particle in the suspension, and this mixture was reacted at 120° C. for 2 hours to hydrophobize the silica particle. Subsequently, the suspension was heated to remove toluene and dried, and then coarse powder was removed with a sieve having an opening of 106 μm to obtain a second silica particle “large silica 1” having an average primary particle diameter of 115 nm.

Second silica particles having different average primary particle diameters were prepared by the same procedure as for the “large silica 1”, and referred to as “large silica 2” to “large silica 5”. The average primary particle diameters of the “large silica 1” to “large silica 5” are presented in Table 3 below. The average primary particle diameters of the “small silica 1” to “small silica 3” are also presented in Table 3.

TABLE 3

| | Average primary |
|---|---|
| Sample name | particle diameter [nm] |
| Small silica 1 | 12 |
| Small silica 2 | 18 |
| Small silica 3 | 23 |
| Large silica 1 | 115 |
| Large silica 2 | 83 |
| Large silica 3 | 145 |
| Large silica 4 | 76 |
| Large silica 5 | 154 |

### <Production of Toner and Developer>

### Example 1

### Preparation of Toner Particle (Mixing, Kneading, Pulverization, and Classification of Raw Material)

For preparation of the toner particle, the following raw materials were used.

### Binder Resin

Amorphous polyester resin: 84% by mass

### Colorant

Carbon black (trade name: Regal 300, manufactured by Cabot Corporation): 6% by mass

### Release Agent

Ester wax (trade name: WEP-3, manufactured by NOF CORPORATION): 3% by mass

### Dispersant for Release Agent

Styrene acrylic copolymer resin (trade name: SA800, manufactured by Mitsui Chemicals, Inc.): 5% by mass-Charge control agent
Salicylic acid compound (trade name: BONTRON E84, manufactured by ORIENT CHEMICAL INDUSTRIES CO.,LTD): 2% by mass

The above raw materials were mixed in an airflow mixer (Henschel mixer, manufactured by NIPPON COKE & ENGINEERING. CO., LTD.) for 5 minutes. The resulting mixture was melt-knead at a cylinder setting temperature of 110° C., a barrel rotational speed of 300 rpm, and a raw material supply speed of 20 kg/hour using a twin-screw extruder (Model: PCM-30, manufactured by Ikegai Corp.) to obtain a melt-kneaded product.

The resulting melt-kneaded product was cooled by a cooling belt, then coarsely pulverized using a cutting mill, then finely pulverized using a jet pulverizer, and further classified using an air classifier to obtain a “toner particle 1” having a volume average particle diameter of 6.5 μm.

### Preparation of Toner (External Addition Step)

### (Preparation of Initial Toner)

To an airflow mixer (Henschel mixer, manufactured by NIPPON COKE & ENGINEERING. CO., LTD.), 100 parts by mass of the resulting “toner particle 1”, 1.0 part by mass of “large silica 1”, and 1.5 part by mass of “small silica 1” were added, and this mixture was stirred at a stirring blade tip speed of 40 m/sec for 2 minutes. Subsequently, 1.0 part by mass of “fine powder 1” was added to this mixture and further stirred for 2 minutes to obtain an initial toner having a volume average particle diameter of 6.5 μm, a fine powder adhesion strength X(Ti) of 84%, and a silica particle adhesion strength X(Si) of 78%.

### (Preparation of Replenishment Toner)

To an airflow mixer (Henschel mixer, manufactured by NIPPON COKE & ENGINEERING. CO., LTD.), 100 parts by mass of the resulting “toner particle 1”, 1.0 part by mass of “large silica 1”, and 1.5 part by mass of “small silica 1” were added, and this mixture was stirred at a stirring blade tip speed of 40 m/sec for 2 minutes. Subsequently, 1.0 part by mass of “titanium dioxide 1” was added to this mixture and further stirred for 2 minutes to obtain a replenishment toner having a volume average particle diameter of 6.5 μm, a titanium dioxide particle adhesion strength Y(Ti) of 82%, and a silica particle adhesion strength Y(Si) of 78%.

### Preparation of Two-Component Developer

The resulting initial toner and a ferrite core carrier having a volume average particle diameter of 40 μm were mixed so that the concentration of the toner was 7% based on the total amount of the two-component developer, to obtain a two-component developer having a toner concentration of 7%.

### Examples 2 to 36, Comparative Examples 1 to 5

As the toner particles, the “toner particle 2” to “toner particle 5” having a volume average particle diameter different from that of “toner particle 1” were prepared. The volume average particle diameters of the “toner particle 1” to “toner particle 5” are presented in Table 4 below.

TABLE 4

| | Volume average |
|---|---|
| Sample name | particle diameter [μm] |
| Toner particle 1 | 6.5 |
| Toner particle 2 | 4.2 |
| Toner particle 3 | 8.8 |
| Toner particle 4 | 3.6 |
| Toner particle 5 | 9.5 |

In Examples 2 to 36 and Comparative Examples 1 to 5, a toner and a two-component developer were prepared in the same manner as in Example 1 except that the toner particle and the external additives for use in preparing the initial toner and the replenishment toner were replaced with those presented in Tables 5 to 8 below.

TABLE 5

| | Initial toner | | | | | | | | | |
|---|---|---|---|---|---|---|---|---|---|---|
| | Toner particle | | Charge control agent | | | | | First silica (small particle diameter) | | |
| | | Volume | | | Average | | | | Average | |
| | | average | | | primary | | | | primary | |
| | | particle | | Si/Ti | particle | Addition | Adhesion | | particle | Addition |
| Sample | | diameter | | molar | diameter | amount | strength | | diameter | amount |
| name | Sample name | [μm] | Sample name | ratio | [nm] | (parts) | X (Ti) [%] | Sample name | [nm] | (parts) |
| Example 1 | Toner particle 1 | 6.5 | Fine powder 1 | 0.05 | 34 | 1.0 | 84 | Small silica 1 | 12 | 1.5 |
| Example 2 | Toner particle 1 | 6.5 | Fine powder 1 | 0.05 | 34 | 0.8 | 83 | Small silica 1 | 12 | 1.5 |
| | | | Titanium dioxide 1 | — | 40 | 0.35 | | | | |
| Example 3 | Toner particle 1 | 6.5 | Fine powder 2 | 0.03 | 34 | 1.0 | 84 | Small silica 1 | 12 | 1.5 |
| Example 4 | Toner particle 1 | 6.5 | Fine powder 3 | 0.95 | 34 | 1.0 | 84 | Small silica 1 | 12 | 1.5 |
| Example 5 | Toner particle 1 | 6.5 | Fine powder 1 | 0.05 | 34 | 0.35 | 86 | Small silica 1 | 12 | 1.5 |
| Example 6 | Toner particle 1 | 6.5 | Fine powder 1 | 0.05 | 34 | 1.45 | 82 | Small silica 1 | 12 | 1.5 |
| Example 7 | Toner particle 1 | 6.5 | Fine powder 1 | 0.05 | 34 | 0.85 | 85 | Small silica 1 | 12 | 1.5 |
| Example 8 | Toner particle 2 | 4.2 | Fine powder 1 | 0.05 | 34 | 1.0 | 84 | Small silica 1 | 12 | 1.5 |
| Example 9 | Toner particle 3 | 8.8 | Fine powder 1 | 0.05 | 34 | 1.0 | 84 | Small silica 1 | 12 | 1.5 |
| Example 10 | Toner particle 1 | 6.5 | Fine powder 6 | 0.05 | 21 | 1.0 | 84 | Small silica 1 | 12 | 1.5 |
| Example 11 | Toner particle 1 | 6.5 | Fine powder 7 | 0.05 | 57 | 1.0 | 84 | Small silica 1 | 12 | 1.5 |
| Example 12 | Toner particle 1 | 6.5 | Fine powder 1 | 0.05 | 34 | 1.0 | 84 | Small silica 1 | 12 | 1.5 |
| Example 13 | Toner particle 1 | 6.5 | Fine powder 1 | 0.05 | 34 | 1.0 | 84 | Small silica 1 | 12 | 1.5 |
| Example 14 | Toner particle 1 | 6.5 | Fine powder 1 | 0.05 | 34 | 1.0 | 84 | Small silica 2 | 18 | 1.5 |
| Example 15 | Toner particle 1 | 6.5 | Fine powder 1 | 0.05 | 34 | 1.0 | 84 | Small silica 1 | 12 | 1.5 |
| Example 16 | Toner particle 1 | 6.5 | Fine powder 1 | 0.05 | 34 | 1.0 | 84 | Small silica 1 | 12 | 1.5 |
| Example 17 | Toner particle 1 | 6.5 | Fine powder 1 | 0.05 | 34 | 1.0 | 86 | Small silica 1 | 12 | 1.0 |
| Example 18 | Toner particle 1 | 6.5 | Fine powder 1 | 0.05 | 34 | 1.0 | 86 | Small silica 1 | 12 | 1.8 |
| Example 19 | Toner particle 1 | 6.5 | Fine powder 1 | 0.05 | 34 | 1.0 | 84 | Small silica 1 | 12 | 1.5 |
| Example 20 | Toner particle 1 | 6.5 | Fine powder 4 | 0.01 | 34 | 1.0 | 84 | Small silica 1 | 12 | 1.5 |
| Example 21 | Toner particle 1 | 6.5 | Fine powder 5 | 1.10 | 34 | 1.0 | 84 | Small silica 1 | 12 | 1.5 |

| | Initial toner | | | | | |
|---|---|---|---|---|---|---|
| | Second silica (large particle diameter) | | | Adhesion | Total | |
| | | Average primary | Addition | strength | amount | Adhesion |
| Sample | | particle diameter | amount | X (Ti) | of silica | strength ratio |
| name | Sample name | [nm] | (parts) | [%] | (parts) | X (Si)/X (Ti) |
| Example 1 | Large silica 1 | 115 | 1.0 | 78 | 2.5 | 0.93 |
| Example 2 | Large silica 1 | 115 | 1.0 | 78 | 2.5 | 0.94 |
| Example 3 | Large silica 1 | 115 | 1.0 | 78 | 2.5 | 0.93 |
| Example 4 | Large silica 1 | 115 | 1.0 | 78 | 2.5 | 0.93 |
| Example 5 | Large silica 1 | 115 | 1.0 | 78 | 2.5 | 0.91 |
| Example 6 | Large silica 1 | 115 | 1.0 | 78 | 2.5 | 0.95 |
| Example 7 | Large silica 1 | 115 | 1.0 | 78 | 2.5 | 0.92 |
| Example 8 | Large silica 1 | 115 | 1.0 | 78 | 2.5 | 0.93 |
| Example 9 | Large silica 1 | 115 | 1.0 | 78 | 2.5 | 0.93 |
| Example 10 | Large silica 1 | 115 | 1.0 | 78 | 2.5 | 0.93 |
| Example 11 | Large silica 1 | 115 | 1.0 | 78 | 2.5 | 0.93 |
| Example 12 | Large silica 1 | 115 | 1.0 | 78 | 2.5 | 0.93 |
| Example 13 | Large silica 1 | 115 | 1.0 | 78 | 2.5 | 0.93 |
| Example 14 | Large silica 1 | 115 | 1.0 | 80 | 2.5 | 0.95 |
| Example 15 | Large silica 2 | 83 | 1.0 | 80 | 2.5 | 0.95 |
| Example 16 | Large silica 3 | 145 | 1.0 | 70 | 2.5 | 0.83 |
| Example 17 | Large silica 1 | 115 | 0.6 | 82 | 1.55 | 0.95 |
| Example 18 | Large silica 1 | 115 | 1.15 | 82 | 2.95 | 0.95 |
| Example 19 | Large silica 1 | 115 | 1.0 | 90 | 2.5 | 1.07 |
| Example 20 | Large silica 1 | 115 | 1.0 | 78 | 2.5 | 0.93 |
| Example 21 | Large silica 1 | 115 | 1.0 | 78 | 2.5 | 0.93 |

TABLE 6

| | Initial toner | | | | | | | | | |
|---|---|---|---|---|---|---|---|---|---|---|
| | Toner particle | | Charge control agent | | | | | First silica (small particle diameter) | | |
| | | Volume | | | Average | | | | Average | |
| | | average | | | primary | | | | primary | |
| | | particle | | Si/Ti | particle | Addition | Adhesion | | particle | Addition |
| | | diameter | | molar | diameter | amount | strength | | diameter | amount |
| Sample name | Sample name | [μm] | Sample name | ratio | [nm] | (parts) | X (Ti) [%] | Sample name | [nm] | (parts) |
| Example 22 | Toner particle 1 | 6.5 | Fine powder 1 | 0.05 | 34 | 0.25 | 87 | Small silica 1 | 12 | 1.5 |
| Example 23 | Toner particle 1 | 6.5 | Fine powder 1 | 0.05 | 34 | 1.55 | 81 | Small silica 1 | 12 | 1.5 |
| Example 24 | Toner particle 1 | 6.5 | Fine powder 2 | 0.05 | 34 | 0.80 | 85 | Small silica 1 | 12 | 1.5 |
| Example 25 | Toner particle 4 | 3.6 | Fine powder 3 | 0.05 | 34 | 1.0 | 84 | Small silica 1 | 12 | 1.5 |
| Example 26 | Toner particle 5 | 9.5 | Fine powder 1 | 0.05 | 34 | 1.0 | 84 | Small silica 1 | 12 | 1.5 |
| Example 27 | Toner particle 1 | 6.5 | Fine powder 8 | 0.05 | 17 | 1.0 | 84 | Small silica 1 | 12 | 1.5 |
| Example 28 | Toner particle 1 | 6.5 | Fine powder 9 | 0.05 | 64 | 1.0 | 84 | Small silica 1 | 12 | 1.5 |
| Example 29 | Toner particle 1 | 6.5 | Fine powder 1 | 0.05 | 34 | 1.0 | 84 | Small silica 1 | 12 | 1.5 |
| Example 30 | Toner particle 1 | 6.5 | Fine powder 1 | 0.05 | 34 | 1.0 | 84 | Small silica 1 | 12 | 1.5 |
| Example 31 | Toner particle 1 | 6.5 | Fine powder 6 | 0.05 | 34 | 1.0 | 84 | Small silica 3 | 23 | 1.5 |
| Example 32 | Toner particle 1 | 6.5 | Fine powder 7 | 0.05 | 34 | 1.0 | 84 | Small silica 1 | 12 | 1.5 |
| Example 33 | Toner particle 1 | 6.5 | Fine powder 1 | 0.05 | 34 | 1.0 | 84 | Small silica 1 | 12 | 1.5 |
| Example 34 | Toner particle 1 | 6.5 | Fine powder 1 | 0.05 | 34 | 1.0 | 86 | Small silica 1 | 12 | 0.8 |
| Example 35 | Toner particle 1 | 6.5 | Fine powder 1 | 0.05 | 34 | 1.0 | 86 | Small silica 1 | 12 | 1.9 |
| Example 36 | Toner particle 1 | 6.5 | Fine powder 1 | 0.05 | 34 | 1.0 | 84 | Small silica 1 | 12 | 1.5 |
| Comparative | Toner particle 1 | 6.5 | Fine powder 1 | 0.05 | 34 | 0.8 | 83 | Small silica 1 | 12 | 1.5 |
| Example 1 | | | Titanium dioxide 1 | — | 40 | 0.45 | | | | |
| Comparative | Toner particle 1 | 6.5 | Fine powder 10 | 0.00 | 34 | 1.0 | 84 | Small silica 1 | 12 | 1.5 |
| Example 2 | | | | | | | | | | |
| Comparative | Toner particle 1 | 6.5 | Titanium dioxide 1 | — | 40 | 1.0 | 82 | Small silica 1 | 12 | 1.5 |
| Example 3 | | | | | | | | | | |
| Comparative | Toner particle 1 | 6.5 | Fine powder 1 | 0.05 | 34 | 1.0 | 84 | Small silica 1 | 12 | 1.5 |
| Example 4 | | | | | | | | | | |
| Comparative | Toner particle 1 | 6.5 | Almina | — | 38 | 1.0 | 86 | Small silica 1 | 12 | 1.5 |
| Example 5 | | | | | | | | | | |

| | Initial toner | | | | | |
|---|---|---|---|---|---|---|
| | Second silica (large particle diameter) | | | | | |
| | | Average primary | Addition | Adhesion | Total amount | Adhesion |
| | | particle diameter | amount | strength | of silica | strength ratio |
| Sample name | Sample name | [nm] | (parts) | X (Ti) [%] | (parts) | X (Si)/X (Ti) |
| Example 22 | Large silica 1 | 115 | 1.0 | 78 | 2.5 | 0.90 |
| Example 23 | Large silica 1 | 115 | 1.0 | 78 | 2.5 | 0.96 |
| Example 24 | Large silica 1 | 115 | 1.0 | 78 | 2.5 | 0.92 |
| Example 25 | Large silica 1 | 115 | 1.0 | 78 | 2.5 | 0.93 |
| Example 26 | Large silica 1 | 115 | 1.0 | 78 | 2.5 | 0.93 |
| Example 27 | Large silica 1 | 115 | 1.0 | 78 | 2.5 | 0.93 |
| Example 28 | Large silica 1 | 115 | 1.0 | 78 | 2.5 | 0.93 |
| Example 29 | Large silica 1 | 115 | 1.0 | 78 | 2.5 | 0.93 |
| Example 30 | Large silica 1 | 115 | 1.0 | 78 | 2.5 | 0.93 |
| Example 31 | Large silica 1 | 115 | 1.0 | 81 | 2.5 | 0.96 |
| Example 32 | Large silica 4 | 76 | 1.0 | 81 | 2.5 | 0.96 |
| Example 33 | Large silica 5 | 154 | 1.0 | 68 | 2.5 | 0.81 |
| Example 34 | Large silica 1 | 115 | 0.5 | 84 | 1.30 | 0.98 |
| Example 35 | Large silica 1 | 115 | 1.20 | 79 | 3.10 | 0.92 |
| Example 36 | Large silica 1 | 115 | 1.0 | 95 | 2.5 | 1.13 |
| Comparative | Large silica 1 | 115 | 1.0 | 78 | 2.5 | 0.94 |
| Example 1 | | | | | | |
| Comparative | Large silica 1 | 115 | 1.0 | 78 | 2.5 | 0.93 |
| Example 2 | | | | | | |
| Comparative | Large silica 1 | 115 | 1.0 | 78 | 2.5 | 0.95 |
| Example 3 | | | | | | |
| Comparative | Large silica 1 | 115 | 1.0 | 78 | 2.5 | 0.93 |
| Example 4 | | | | | | |
| Comparative | Large silica 1 | 115 | 1.0 | 78 | 2.5 | 0.91 |
| Example 5 | | | | | | |

TABLE 7

| | Replenishment toner | | | | | | | | |
|---|---|---|---|---|---|---|---|---|---|
| | | | | | | | First silica (small particle | | |
| | Toner particle | | Charge control agent | | | | diameter) | | |
| | | Volume | | Average | | | | Average | |
| | | average | | primary | | Adhesion | | primary | |
| | | particle | | particle | Addition | strength | | particle | Addition |
| | | diameter | | diameter | amount | Y (Ti) | | diameter | amount |
| Sample name | Sample name | [μm] | Sample name | [nm] | (parts) | [%] | Sample name | [nm] | (parts) |
| Example 1 | Toner particle 1 | 6.5 | Titanium dioxide 1 | 40 | 1.0 | 82 | Small silica 1 | 12 | 1.5 |
| Example 2 | Toner particle 1 | 6.5 | Titanium dioxide 1 | 40 | 0.8 | 83 | Small silica 1 | 12 | 1.5 |
| | | | Fine powder 1 | 34 | 0.35 | | | | |
| Example 3 | Toner particle 1 | 6.5 | Titanium dioxide 1 | 40 | 1.0 | 82 | Small silica 1 | 12 | 1.5 |
| Example 4 | Toner particle 1 | 6.5 | Titanium dioxide 1 | 40 | 1.0 | 82 | Small silica 1 | 12 | 1.5 |
| Example 5 | Toner particle 1 | 6.5 | Titanium dioxide 1 | 40 | 0.35 | 86 | Small silica 1 | 12 | 1.5 |
| Example 6 | Toner particle 1 | 6.5 | Titanium dioxide 1 | 40 | 1.45 | 80 | Small silica 1 | 12 | 1.5 |
| Example 7 | Toner particle 1 | 6.5 | Titanium dioxide 1 | 40 | 1.1 | 82 | Small silica 1 | 12 | 1.5 |
| Example 8 | Toner particle 2 | 4.2 | Titanium dioxide 1 | 40 | 1.0 | 82 | Small silica 1 | 12 | 1.5 |
| Example 9 | Toner particle 3 | 8.8 | Titanium dioxide 1 | 40 | 1.0 | 82 | Small silica 1 | 12 | 1.5 |
| Example 10 | Toner particle 1 | 6.5 | Titanium dioxide 1 | 40 | 1.0 | 82 | Small silica 1 | 12 | 1.5 |
| Example 11 | Toner particle 1 | 6.5 | Titanium dioxide 1 | 40 | 1.0 | 82 | Small silica 1 | 12 | 1.5 |
| Example 12 | Toner particle 1 | 6.5 | Titanium dioxide 2 | 22 | 1.0 | 82 | Small silica 1 | 12 | 1.5 |
| Example 13 | Toner particle 1 | 6.5 | Titanium dioxide 3 | 56 | 1.0 | 82 | Small silica 1 | 12 | 1.5 |
| Example 14 | Toner particle 1 | 6.5 | Titanium dioxide 1 | 40 | 1.0 | 82 | Small silica 2 | 18 | 1.5 |
| Example 15 | Toner particle 1 | 6.5 | Titanium dioxide 1 | 40 | 1.0 | 82 | Small silica 1 | 12 | 1.5 |
| Example 16 | Toner particle 1 | 6.5 | Titanium dioxide 1 | 40 | 1.0 | 82 | Small silica 1 | 12 | 1.5 |
| Example 17 | Toner particle 1 | 6.5 | Titanium dioxide 1 | 40 | 1.0 | 86 | Small silica 1 | 12 | 1.0 |
| Example 18 | Toner particle 1 | 6.5 | Titanium dioxide 1 | 40 | 1.0 | 86 | Small silica 1 | 12 | 1.8 |
| Example 19 | Toner particle 1 | 6.5 | Titanium dioxide 1 | 40 | 1.0 | 82 | Small silica 1 | 12 | 1.5 |
| Example 20 | Toner particle 1 | 6.5 | Titanium dioxide 1 | 40 | 1.0 | 82 | Small silica 1 | 12 | 1.5 |
| Example 21 | Toner particle 1 | 6.5 | Titanium dioxide 1 | 40 | 1.0 | 82 | Small silica 1 | 12 | 1.5 |

| | | | | | | | Difference of |
|---|---|---|---|---|---|---|---|
| | Replenishment toner | | | | | | addition amount |
| | Second silica (large particle diameter) | | | | | | B − A (A: fine |
| | | Average | | | | | powder in the |
| | | primary | | Adhesion | Total | Adhesion | initial toner, |
| | | particle | Addition | strength | amount | strength | B: TiO₂ in the |
| | | diameter | amount | Y (Si) | of silica | ratio | replenishment |
| Sample name | Sample name | [nm] | (parts) | [%] | (parts) | Y (Si)/Y (Ti) | toner) |
| Example 1 | Large silica 1 | 115 | 1.0 | 78 | 2.5 | 0.95 | 0 |
| Example 2 | Large silica 1 | 115 | 1.0 | 78 | 2.5 | 0.94 | 0 |
| | | | | | | | 0 |
| Example 3 | Large silica 1 | 115 | 1.0 | 78 | 2.5 | 0.95 | 0 |
| Example 4 | Large silica 1 | 115 | 1.0 | 78 | 2.5 | 0.95 | 0 |
| Example 5 | Large silica 1 | 115 | 1.0 | 78 | 2.5 | 0.91 | 0 |
| Example 6 | Large silica 1 | 115 | 1.0 | 78 | 2.5 | 0.98 | 0 |
| Example 7 | Large silica 1 | 115 | 1.0 | 78 | 2.5 | 0.95 | 0.25 |
| Example 8 | Large silica 1 | 115 | 1.0 | 78 | 2.5 | 0.95 | 0 |
| Example 9 | Large silica 1 | 115 | 1.0 | 78 | 2.5 | 0.95 | 0 |
| Example 10 | Large silica 1 | 115 | 1.0 | 78 | 2.5 | 0.95 | 0 |
| Example 11 | Large silica 1 | 115 | 1.0 | 78 | 2.5 | 0.95 | 0 |
| Example 12 | Large silica 1 | 115 | 1.0 | 78 | 2.5 | 0.95 | 0 |
| Example 13 | Large silica 1 | 115 | 1.0 | 78 | 2.5 | 0.95 | 0 |
| Example 14 | Large silica 1 | 115 | 1.0 | 80 | 2.5 | 0.98 | 0 |
| Example 15 | Large silica 2 | 83 | 1.0 | 80 | 2.5 | 0.98 | 0 |
| Example 16 | Large silica 3 | 145 | 1.0 | 70 | 2.5 | 0.85 | 0 |
| Example 17 | Large silica 1 | 115 | 0.6 | 82 | 1.55 | 0.95 | 0 |
| Example 18 | Large silica 1 | 115 | 1.15 | 82 | 2.95 | 0.95 | 0 |
| Example 19 | Large silica 1 | 115 | 1.0 | 88 | 2.5 | 1.07 | 0 |
| Example 20 | Large silica 1 | 115 | 1.0 | 78 | 2.5 | 0.95 | 0 |
| Example 21 | Large silica 1 | 115 | 1.0 | 78 | 2.5 | 0.95 | 0 |

TABLE 8

| | Replenishment toner | | | | | | | | |
|---|---|---|---|---|---|---|---|---|---|
| | Toner particle | | Charge control agent | | | | First silica (small particle diameter) | | |
| | | Volume | | Average | | | | Average | |
| | | average | | primary | | Adhesion: | | primary | |
| | | particle | | particle | Addition | strength | | particle | Addition |
| | | diameter | | diameter | amount | Y (Ti) | | diameter | amount |
| Sample name | Sample name | [μm] | Sample name | [nm] | (parts) | [%] | Sample name | [nm] | (parts) |
| Example 22 | Toner particle 1 | 6.5 | Titanium dioxide 1 | 40 | 0.25 | 87 | Small silica 1 | 12 | 1.5 |
| Example 23 | Toner particle 1 | 6.5 | Titanium dioxide 1 | 40 | 1.55 | 79 | Small silica 1 | 12 | 1.5 |
| | | | Fine powder 1 | 40 | 1.15 | | | | |
| Example 24 | Toner particle 1 | 6.5 | Titanium dioxide 1 | 40 | 1.6 | 82 | Small silica 1 | 12 | 1.5 |
| Example 25 | Toner particle 4 | 3.6 | Titanium dioxide 1 | 40 | 1.0 | 82 | Small silica 1 | 12 | 1.5 |
| Example 26 | Toner particle 5 | 9.5 | Titanium dioxide 1 | 40 | 1.0 | 82 | Small silica 1 | 12 | 1.5 |
| Example 27 | Toner particle 1 | 6.5 | Titanium dioxide 1 | 40 | 1.0 | 82 | Small silica 1 | 12 | 1.5 |
| Example 28 | Toner particle 1 | 6.5 | Titanium dioxide 1 | 40 | 1.0 | 82 | Small silica 1 | 12 | 1.5 |
| Example 29 | Toner particle 1 | 6.5 | Titanium dioxide 4 | 18 | 1.0 | 82 | Small silica 1 | 12 | 1.5 |
| Example 30 | Toner particle 1 | 6.5 | Titanium dioxide 5 | 63 | 1.0 | 82 | Small silica 1 | 12 | 1.5 |
| Example 31 | Toner particle 1 | 6.5 | Titanium dioxide 1 | 40 | 1.0 | 82 | Small silica 3 | 23 | 1.5 |
| Example 32 | Toner particle 1 | 6.5 | Titanium dioxide 1 | 40 | 1.0 | 82 | Small silica 1 | 12 | 1.5 |
| Example 33 | Toner particle 1 | 6.5 | Titanium dioxide 2 | 40 | 1.0 | 82 | Small silica 1 | 12 | 1.5 |
| Example 34 | Toner particle 1 | 6.5 | Titanium dioxide 3 | 40 | 1.0 | 86 | Small silica 1 | 12 | 0.8 |
| Example 35 | Toner particle 1 | 6.5 | Titanium dioxide 1 | 40 | 1.0 | 86 | Small silica 1 | 12 | 1.9 |
| Example 36 | Toner particle 1 | 6.5 | Titanium dioxide 1 | 40 | 1.0 | 82 | Small silica 1 | 12 | 1.5 |
| Comparative | Toner particle 1 | 6.5 | Titanium dioxide 1 | 40 | 0.8 | 83 | Small silica 1 | 12 | 1.5 |
| Example 1 | | | Fine powder 1 | 34 | 0.45 | | | | |
| Comparative | Toner particle 1 | 6.5 | Titanium dioxide 1 | 40 | 1.0 | 82 | Small silica 1 | 12 | 1.5 |
| Example 2 | | | | | | | | | |
| Comparative | Toner particle 1 | 6.5 | Titanium dioxide 1 | 40 | 1.0 | 82 | Small silica 1 | 12 | 1.5 |
| Example 3 | | | | | | | | | |
| Comparative | Toner particle 1 | 6.5 | Fine powder 1 | 34 | 1.0 | 84 | Small silica 1 | 12 | 1.5 |
| Example 4 | | | | | | | | | |
| Comparative | Toner particle 1 | 6.5 | Titanium dioxide 1 | 40 | 1.0 | 82 | Small silica 1 | 12 | 1.5 |
| Example 5 | | | | | | | | | |

| | | | | | | | Difference of |
|---|---|---|---|---|---|---|---|
| | Replenishment toner | | | | | | addition amount |
| | Second silica (large particle diameter) | | | | | | B − A (A: fine |
| | | Average | | | | | powder in the |
| | | primary | | Adhesion | Total | Adhesion | initial toner, |
| | | particle | | strength | amount | strength | B: TiO₂ in the |
| | | diameter | Addition | Y (Si) | of silica | ratio | replenishment |
| Sample name | Sample name | [nm] | amount (parts) | [%] | (parts) | Y (Si)/Y (Ti) | toner) |
| Example 22 | Large silica 1 | 115 | 1.0 | 78 | 2.5 | 0.90 | 0 |
| Example 23 | Large silica 1 | 115 | 1.0 | 78 | 2.5 | 0.99 | 0 |
| | | | | | | | 0 |
| Example 24 | Large silica 1 | 115 | 1.0 | 78 | 2.5 | 0.95 | 0.35 |
| Example 25 | Large silica 1 | 115 | 1.0 | 78 | 2.5 | 0.95 | 0 |
| Example 26 | Large silica 1 | 115 | 1.0 | 78 | 2.5 | 0.95 | 0 |
| Example 27 | Large silica 1 | 115 | 1.0 | 78 | 2.5 | 0.95 | 0 |
| Example 28 | Large silica 1 | 115 | 1.0 | 78 | 2.5 | 0.95 | 0 |
| Example 29 | Large silica 1 | 115 | 1.0 | 78 | 2.5 | 0.95 | 0 |
| Example 30 | Large silica 1 | 115 | 1.0 | 78 | 2.5 | 0.95 | 0 |
| Example 31 | Large silica 1 | 115 | 1.0 | 82 | 2.5 | 1.00 | 0 |
| Example 32 | Large silica 4 | 76 | 1.0 | 81 | 2.5 | 0.99 | 0 |
| Example 33 | Large silica 5 | 154 | 1.0 | 68 | 2.5 | 0.83 | 0 |
| Example 34 | Large silica 1 | 115 | 0.5 | 84 | 1.30 | 0.98 | 0 |
| Example 35 | Large silica 1 | 115 | 1.20 | 79 | 3.10 | 0.92 | 0 |
| Example 36 | Large silica 1 | 115 | 1.0 | 93 | 2.5 | 1.13 | 0 |
| Comparative | Large silica 1 | 115 | 1.0 | 78 | 2.5 | 0.94 | 0 |
| Example 1 | | | | | | | |
| Comparative | Large silica 1 | 115 | 1.0 | 78 | 2.5 | 0.95 | 0 |
| Example 2 | | | | | | | |
| Comparative | Large silica 1 | 115 | 1.0 | 78 | 2.5 | 0.95 | 0 |
| Example 3 | | | | | | | |
| Comparative | Large silica 1 | 115 | 1.0 | 78 | 2.5 | 0.93 | 0 |
| Example 4 | | | | | | | |
| Comparative | Large silica 1 | 115 | 1.0 | 78 | 2.5 | 0.95 | 0 |
| Example 5 | | | | | | | |

TABLE 9

| | Image density | | | | Image density uniformity | | | | Fogging | | | |
|---|---|---|---|---|---|---|---|---|---|---|---|---|
| | First | | Second | | First | | Second | | First | | Second | |
| Sample | (Early stage) | | (after printing) | | (Early stage) | | (after printing) | | (Early stage) | | (after printing) | |
| name | Value | Evaluation | Value | Evaluation | Value | Evaluation | Value | Evaluation | Value | Evaluation | Value | Evaluation |
| Example 1 | 1.55 | Excellent | 1.57 | Excellent | 0.05 | Excellent | 0.04 | Excellent | 0.5 | Excellent | 0.7 | Excellent |
| Example 2 | 1.32 | Good | 1.49 | Excellent | 0.06 | Excellent | 0.04 | Excellent | 0.6 | Excellent | 1.5 | Good |
| Example 3 | 1.48 | Excellent | 1.50 | Excellent | 0.08 | Excellent | 0.16 | Good | 1.1 | Excellent | 0.8 | Excellent |
| Example 4 | 1.39 | Good | 1.52 | Excellent | 0.03 | Excellent | 0.07 | Excellent | 0.7 | Excellent | 0.7 | Excellent |
| Example 5 | 1.31 | Good | 1.33 | Good | 0.18 | Good | 0.05 | Excellent | 1.0 | Excellent | 1.2 | Excellent |
| Example 6 | 1.48 | Excellent | 1.51 | Excellent | 0.06 | Excellent | 0.05 | Excellent | 1.4 | Good | 1.5 | Good |
| Example 7 | 1.49 | Excellent | 1.55 | Excellent | 0.09 | Excellent | 0.13 | Good | 1.1 | Excellent | 1.6 | Good |
| Example 8 | 1.40 | Good | 1.38 | Good | 0.12 | Good | 0.17 | Good | 1.0 | Excellent | 1.5 | Good |
| Example 9 | 1.50 | Excellent | 1.52 | Excellent | 0.05 | Excellent | 0.14 | Good | 0.9 | Excellent | 0.8 | Excellent |
| Example 10 | 1.46 | Excellent | 1.49 | Excellent | 0.08 | Excellent | 0.15 | Good | 1.0 | Excellent | 1.3 | Excellent |
| Example 11 | 1.53 | Excellent | 1.50 | Excellent | 0.17 | Good | 0.16 | Good | 1.6 | Good | 1.4 | Good |
| Example 12 | 1.50 | Excellent | 1.52 | Excellent | 0.06 | Excellent | 0.13 | Good | 1.1 | Excellent | 1.0 | Excellent |
| Example 13 | 1.47 | Excellent | 1.55 | Excellent | 0.08 | Excellent | 0.15 | Good | 0.9 | Excellent | 1.5 | Good |
| Example 14 | 1.50 | Excellent | 1.46 | Excellent | 0.15 | Good | 0.14 | Good | 0.8 | Excellent | 0.9 | Excellent |
| Example 15 | 1.52 | Excellent | 1.52 | Excellent | 0.06 | Excellent | 0.12 | Good | 1.2 | Excellent | 1.0 | Excellent |
| Example 16 | 1.54 | Excellent | 1.49 | Excellent | 0.14 | Good | 0.13 | Good | 1.1 | Excellent | 1.3 | Excellent |
| Example 17 | 1.47 | Excellent | 1.49 | Excellent | 0.07 | Excellent | 0.13 | Good | 0.8 | Excellent | 1.5 | Good |
| Example 18 | 1.50 | Excellent | 1.53 | Excellent | 0.06 | Excellent | 0.07 | Excellent | 1.0 | Excellent | 1.6 | Good |
| Example 19 | 1.48 | Excellent | 1.52 | Excellent | 0.08 | Excellent | 0.05 | Excellent | 1.1 | Excellent | 1.5 | Good |
| Example 20 | 1.50 | Excellent | 1.47 | Excellent | 0.06 | Excellent | 0.28 | Fair | 0.9 | Excellent | 0.9 | Excellent |
| Example 21 | 1.22 | Fair | 1.46 | Excellent | 0.05 | Excellent | 0.05 | Excellent | 1.2 | Excellent | 0.8 | Excellent |
| Example 22 | 1.19 | Fair | 1.27 | Fair | 0.27 | Fair | 0.09 | Excellent | 1.6 | Good | 1.1 | Excellent |
| Example 23 | 1.35 | Good | 1.39 | Good | 0.04 | Excellent | 0.15 | Good | 1.9 | Fair | 2.1 | Fair |
| Example 24 | 1.52 | Excellent | 1.50 | Excellent | 0.06 | Excellent | 0.29 | Fair | 0.9 | Excellent | 1.7 | Fair |
| Example 25 | 1.48 | Excellent | 1.51 | Excellent | 0.08 | Excellent | 0.26 | Fair | 1.1 | Excellent | 1.5 | Good |
| Example 26 | 1.50 | Excellent | 1.53 | Excellent | 0.31 | Fair | 0.33 | Fair | 1.4 | Good | 1.5 | Good |
| Example 27 | 1.48 | Excellent | 1.50 | Excellent | 0.28 | Fair | 0.32 | Fair | 0.9 | Excellent | 0.9 | Excellent |
| Example 28 | 1.52 | Excellent | 1.52 | Excellent | 0.16 | Good | 0.3 | Fair | 1.0 | Excellent | 1.2 | Excellent |
| Example 29 | 1.49 | Excellent | 1.47 | Excellent | 0.04 | Excellent | 0.22 | Fair | 0.8 | Excellent | 1.0 | Excellent |
| Example 30 | 1.51 | Excellent | 1.53 | Excellent | 0.05 | Excellent | 0.31 | Fair | 1.2 | Excellent | 1.5 | Good |
| Example 31 | 1.50 | Excellent | 1.53 | Excellent | 0.27 | Fair | 0.36 | Fair | 0.8 | Excellent | 1.0 | Excellent |
| Example 32 | 1.48 | Excellent | 1.48 | Excellent | 0.07 | Excellent | 0.29 | Fair | 1.2 | Excellent | 1.1 | Excellent |
| Example 33 | 1.52 | Excellent | 1.49 | Excellent | 0.34 | Fair | 0.25 | Fair | 1.0 | Excellent | 0.8 | Excellent |
| Example 34 | 1.46 | Excellent | 1.51 | Excellent | 0.05 | Excellent | 0.29 | Fair | 0.9 | Excellent | 1.8 | Fair |
| Example 35 | 1.55 | Excellent | 1.47 | Excellent | 0.04 | Excellent | 0.07 | Excellent | 1.2 | Excellent | 1.9 | Fair |
| Example 36 | 1.50 | Excellent | 1.50 | Excellent | 0.08 | Excellent | 0.05 | Excellent | 1.0 | Excellent | 1.9 | Fair |
| Comparative | 1.28 | Fair | 1.53 | Excellent | 0.06 | Excellent | 0.05 | Excellent | 1.3 | Excellent | 2.2 | Poor |
| Example 1 | | | | | | | | | | | | |
| Comparative | 1.51 | Excellent | 1.55 | Excellent | 0.05 | Excellent | 0.42 | Poor | 1.4 | Good | 1.7 | Fair |
| Example 2 | | | | | | | | | | | | |
| Comparative | 1.12 | Poor | 1.47 | Excellent | 0.07 | Excellent | 0.06 | Excellent | 1.1 | Excellent | 1.2 | Excellent |
| Example 3 | | | | | | | | | | | | |
| Comparative | 1.46 | Excellent | 1.49 | Excellent | 0.05 | Excellent | 0.08 | Excellent | 0.9 | Excellent | 2.1 | Poor |
| Example 4 | | | | | | | | | | | | |
| Comparative | 1.50 | Excellent | 1.53 | Excellent | 0.06 | Excellent | 0.44 | Poor | 2.3 | Poor | 1.2 | Excellent |
| Example 5 | | | | | | | | | | | | |

Tables 5 and 6 present the types, addition amounts, and properties of the raw materials used for preparing the initial toners in Examples and Comparative Examples. Tables 7 and 8 present the types, addition amounts, and properties of the raw materials used for preparing the replenishment toners in Examples and Comparative Examples. Table 9 presents the measurement results and evaluation results in Examples and Comparative Examples.

In Examples 1 to 36, the initial toner contains, as external additives, a fine powder and a silica particle, and does not contain any titanium dioxide particle or contains a titanium dioxide particle at 50% by mass or less of the fine powder. Also in Examples 1 to 36, the replenishment toner contains, as external additives, a titanium dioxide particle and a silica particle, and does not contain any fine powder or contains a fine powder at 50% by mass or less of the titanium dioxide particle. As shown in Table 7, in Examples 1 to 36 that satisfied these requirements, an excellent image density and uniformity could be maintained and fogging could be suppressed over a long period of time.

In contrast, in Comparative Examples 1 to 5 that did not satisfy these requirements, evaluation results of the image density, the image density uniformity, and fogging were inferior to Examples in the continuous printing test.

It can be seen that, in Examples 1, 3, 4, and the like in which a molar ratio of silicon atom to titanium atom in the fine powder is 0.03 or higher and 1.00 or lower, evaluation results of the image density uniformity after the continuous printing are superior to Example 20 with the silicon atom molar ratio of lower than the lower limit described above. Also, it can be seen that, in Examples 1, 3, 4, and the like, evaluation results for the image density at the early stage of the printing are superior to Example 21 with the molar ratio of higher than the upper limit described above.

It can be seen that, in Examples 1, 5, 6, and the like in which a content of the fine powder based on 100 parts by mass of the toner particle in the initial toner is 0.3 part by mass or more and 1.5 part by mass or less and a content of the titanium dioxide particle based on 100 parts by mass of the toner particle in the replenishment toner is 0.3 part by mass or more and 1.5 part by mass or less, evaluation results of the image density and the image density uniformity at the early stage of the printing are superior to Example 22 with the contents of the fine powder and the titanium dioxide particle of less than the lower limits described above. Also, it can be seen that, in Examples 1, 5, 6, and the like, evaluation results of the fogging are superior to Example 23 with the contents of the fine powder and the titanium dioxide particle of more than the upper limits described above.

It can be seen that, in Examples 1, 7, and the like in which, under a condition that the content of the fine powder based on 100 parts by mass of the toner particle in the initial toner is defined as A part by mass and the content of the titanium dioxide particle based on 100 parts by mass of the toner particle in the replenishment toner is defined as B part by mass, a solution of an equation “B−A” is 0.3 or smaller, evaluation results of the image density uniformity and the fogging after the continuous printing are superior to Example 24 with the equation “B−A” solution of larger than the upper limit described above.

It can be seen that, in Examples 1, 8 to 13, and the like in which the toner particle in the initial toner and the replenishment toner has a volume average particle diameter of 4 μm or larger and 9 μm or smaller and the fine powder and the titanium dioxide particle in the initial toner and the replenishment toner have an average primary particle diameter of 20 nm or larger and 60 nm or smaller, evaluation results of the image density uniformity are superior to Examples 25 to 30 in which the average primary particle diameter is out of the range described above.

It can be seen that, in Examples 1, 14 to 16, and the like in which the silica particle as the external additive contained in the initial toner and the replenishment toner includes a first silica particle having an average primary particle diameter of 20 nm or smaller and a second silica particle having an average primary particle diameter of 80 nm or larger and 150 nm or smaller, evaluation results of the image density uniformity are superior to Examples 31 to 33 in which the average primary particle diameter of the first or second silica particle is out of the range described above.

It can be seen that, in Examples 1, 17, 18, and the like in which a content of the silica particle based on 100 parts by mass of the toner particle in the initial toner is 1.5 part by mass or more and 3.0 parts by mass or less and a content of the silica particle based on 100 parts by mass of the toner particle in the replenishment toner is 1.5 part by mass or more and 3.0 parts by mass or less, evaluation results of the image density uniformity and the fogging after the continuous printing are superior to Example 34 with the silica particle content of less than the lower limit described above. Also, it can be seen that, in Examples 1, 17, 18, and the like, evaluation results of the fogging after the continuous printing are superior to Example 35 with the silica particle content of more than the upper limit described above.

It can be seen that, in Examples 1, 19, and the like in which, under a condition that an adhesion strength of the fine powder and the titanium dioxide particle to the toner particle is defined as X(Ti) and an adhesion strength of the silica particle to the toner particle is defined as X(Si) in the initial toner, a ratio X(Si)/X(Ti) is 1.1 or lower, and under a condition that an adhesion strength of the fine particle and the titanium dioxide particle to the toner particle is defined as Y(Ti) and an adhesion strength of the silica particle to the toner particle is defined as Y(Si) in the replenishment toner, a ratio Y(Si)/Y(Ti) is 1.1 or lower, evaluation results of the fogging after the continuous printing are superior to Example 36 with the ratios X(Si)/X(Ti) and Y(Si)/Y(Ti) higher than the upper limits described above.

The embodiments disclosed herein are merely exemplary in all respects, and do not constitute grounds for restrictive interpretation. Accordingly, the technical scope of the present disclosure is not construed only by the embodiments described above, but defined on the basis of the recitation of claims. The technical scope of the present disclosure embraces all modifications within a sense and scope equivalent to those in claims.

What is claimed is:

1. An image forming apparatus, wherein
a two-component developer including an initial toner and a carrier is previously charged into a developer tank, and a replenishment toner is replenished into the developer tank as the development proceeds,
the initial toner and the replenishment toner include a toner particle with a surface stuck with an external additive,
the initial toner contains, as an external additive, a fine powder prepared by adding silica to strontium titanate to form a core and hydrophobizing a surface of the core with a silane compound, and a silica particle, and does not contain any titanium dioxide particle or contains a titanium dioxide particle at 50% by mass or less of the fine powder,
the replenishment toner contains, as an external additive, a titanium dioxide particle and a silica particle, and does not contain the fine powder or contains the fine powder at 50% by mass or less of the titanium dioxide particle.

2. The image forming apparatus according to claim 1, wherein
a molar ratio of silicon atom to titanium atom in the fine powder is 0.03 or higher and 1.00 or lower.

3. The image forming apparatus according to claim 1, wherein
a content of the fine powder based on 100 parts by mass of the toner particle in the initial toner is 0.3 part by mass or more and 1.5 part by mass or less, and
a content of the titanium dioxide particle based on 100 parts by mass of the toner particle in the replenishment toner is 0.3 part by mass or more and 1.5 part by mass or less.

4. The image forming apparatus according to claim 1, wherein
under a condition that the content of the fine powder based on 100 parts by mass of the toner particle in the initial toner is defined as A part by mass and the content of the titanium dioxide particle based on 100 parts by mass of the toner particle in the replenishment toner is defined as B part by mass, an equation “B−A=0.3 or less” is established.

5. The image forming apparatus according to claim 1, wherein
the toner particle in the initial toner and in the replenishment toner has a volume average particle diameter of 4 μm or larger and 9 μm or smaller, and
the fine powder and the titanium dioxide particle in the initial toner and in the replenishment toner have an average primary particle diameter of 20 nm or larger and 60 nm or smaller.

6. The image forming apparatus according to claim 1, wherein
the silica particle as the external additive contained in the initial toner and the replenishment toner includes a first silica particle having an average primary particle diameter of 20 nm or smaller and a second silica particle having an average primary particle diameter of 80 nm or larger and 150 nm or smaller.

7. The image forming apparatus according to claim 1, wherein
a content of the silica particle based on 100 parts by mass of the toner particle in the initial toner is 1.5 part by mass or more and 3.0 part by mass or less, and
a content of the silica particle based on 100 parts by mass of the toner particle in the replenishment toner is 1.5 part by mass or more and 3.0 parts by mass or less.

8. The image forming apparatus according to claim 1, wherein
under a condition that an adhesion strength of the fine powder and the titanium dioxide particle to the toner particle is defined as X(Ti) and an adhesion strength of the silica particle to the toner particle is defined as X(Si) in the initial toner, a ratio X(Si)/X(Ti) is 1.1 or lower, and
under a condition that an adhesion strength of the fine powder and the titanium dioxide particle to the toner particle is defined as Y(Ti) and an adhesion strength of the silica particle to the toner particle is defined as Y(Si) in the replenishment toner, a ratio Y(Si)/Y(Ti) is 1.1 or lower.
